(19) United States
(12) Patent Application Publication
(10) Pub. No.: US 2007/0291164 A1
(43) Pub. Date: Dec. 20, 2007

(54) Compact and miniature optical navigation device

(76) Inventors: Kee-Siang Goh, Penang (MY); Kean-Leong Tai, Bukit Mertajam (MY); Gurbir Singh A/L Balwant Singh, Penang (MY); Bily Wang, Hsin Chu City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/454,900

(22) Filed: Jun. 19, 2006

(51) Int. Cl. H04N 5/222

(52) U.S. Cl. 348/370

(57) ABSTRACT

A compact and miniature optical navigation device integrates an illumination channel and an imaging channel into single piece. The present invention integrates the optical system, the mechanical system, and the electrical system into a small form factor device. The compact and miniature optical navigation device includes a photo-imaging element, a housing, and a first substrate. The photo-imaging element comprises an imaging channel and an illumination channel. The housing includes an aperture stop and an alignment element. The aperture stop and the housing are integrated into one piece and the alignment element is part of the housing. The first substrate includes a light source and a sensor. The light source and the sensor are located on the same surface of the first substrate. The light emitted from the light source passes through the illumination channel, reflected from the navigating surface and forms the image on the sensor.

### BACKGROUND OF THE INVENTION

1. Field of the Invention

The present invention relates to a compact and miniature optical navigation device. In particular, the present invention relates to a compact and miniature optical navigation device that is composed of a light source and a sensor.

2. Description of the Related Art

An optical navigation device typically consists of an optical imaging sensor and an imaging processing chip used for recording images of a surface that the optical navigation device is navigating over. The sensor captures images of the surface and compares the subsequent image of the surface when the optical navigation device is navigating. The images are recorded at a very high rate. The sensor incorporates electronic circuitry to compute and determine where the optical navigation device moves in horizontal and vertical directions.

FIG. 1 shows a schematic diagram of the optical navigation device of the prior art. The optical navigation sensor device typically includes a light source (not shown in the figure), such as an LED, for illuminating a defined area of the surface that the optical navigation device is resting upon, and generating a reflected image of the illuminated surface. There is also another channel where the image of the illuminated are is formed onto the sensor. In the conventional method, these two channels are defined as the illumination channel and the imaging channel respectively.

When the optical navigation device is assembled, the sensor 10 is attached onto a first printed circuit board 12. Then, a base plate alignment post 16 is used for attaching the first printed circuit board 12 onto a second printed circuit board 14. Finally, the assembled part is pressed and attached by a clip 19 and a plastic spring 18.

However, the light source and the sensor of the optical navigation device are independent and they are not located on a common platform during assembly. Therefore, the assembly is difficult and the cost of the optical navigation device is expensive. Furthermore, due to the design structure of the optical navigation device, the height of the optical navigation device of the prior art is higher. Therefore, it cannot be applied to a small form factor product or a device having multiple chips. The illumination channel and the imaging channel of the optical navigation device of the prior art have therefore not been systematized. Overall functional testing of the optical navigation device is done independently. During the assembling process, mechanical alignment of the optical navigation device is more complex and difficult.

### SUMMARY OF THE INVENTION

One particular aspect of the present invention is to provide a compact and miniature optical navigation device. The compact and miniature optical navigation device is packaged at a system level with multiple chips, including a source (such as a light source) and a detector etc, for providing the required optical illumination channel and imaging channel. The entire system is packaged in a small form factor such that its assembly can be applied in various small form outlines with the ease of surface mounting capabilities.

Another particular aspect of the present invention is to provide a compact and miniature optical navigation device. The compact and miniature optical navigation device can be used in various applications ranging from a hand held navigation tool suitable for application in cell phones to that of computer or lap top navigation devices. With the application in cell phones, this gives the user the mobility of moving the curser 360 degrees around the display.

A further particular aspect of the present invention is to provide a compact and miniature optical navigation device. The compact and miniature optical navigation device integrates the illumination channel and the imaging channel into one piece to achieve the effects of miniaturizing the device and simplifying the manufacturing process. The novelty of the present invention is the integration of the optical system, mechanical structure and electronic system into a small form factor package.

In another preferred embodiment, the navigation device consists of one single piece part which integrates the imaging and illumination channel with an opening through hole in between the imaging channel and illumination channel. One completion of the assembly of this package, the module will be surface mounted on the customer's board. In order to reduce the total height of the module, a through hole that fits the outline of the package is drilled or punched. Surface mounting pads which match a similar surface mounting pad on the substrate of the package is then interconnected through a conductive material typically solder. Having this feature allows the overall package height to be reduced depending on the customer board thickness.

The compact and miniature optical navigation device includes a photo-imaging element, a housing, and a first substrate. The photo-imaging element is composed of an imaging channel and an illumination channel that are integrated into one piece. The housing includes an aperture stop and an alignment element. The aperture stop and the housing are integrated into one piece and the alignment element is part of the housing and is used for wrapping and positioning the photo-imaging element. The first substrate includes a light source and a sensor. The light source and the sensor are mounted on the same plane of the first substrate. The light emitted from the light source passes through the illumination channel, reflected from the navigating surface and forms the image on the sensor through the imaging channel.

The compact and miniature optical navigation device includes a photo-imaging element, a housing, and a first substrate. The photo-imaging element comprises an illumination channel composed of a collimating surface, a total internal reflection surface, and a photo wedge and an imaging channel that is an imaging lens having an aspheric surface that are integrated into one piece. The housing is used for holding and positioning the photo-imaging element. The first substrate includes a light source and a sensor. The light source and the sensor are mounted on the same plane of the first substrate. The light emitted from the light source passes through the illumination channel, reflected from the navigating surface and forms the image on the sensor through the imaging channel.

For further understanding of the invention, reference is made to the following detailed description illustrating the embodiments and examples of the invention. The description is only for illustrating the invention and is not intended to be considered limiting of the scope of the claim.

### BRIEF DESCRIPTION OF THE DRAWINGS

The drawings included herein provide a further understanding of the invention. A brief introduction of the drawings is as follows:

FIG. 1 is a schematic diagram of the compact and miniature optical navigation device of the prior art;

FIG. 2 is a schematic diagram of the first embodiment of the compact and miniature optical navigation device of the present invention;

FIG. 3 is a schematic diagram of the first embodiment of the photo-imaging element of the compact and miniature optical navigation device of the present invention;

FIG. 4 is a schematic diagram of the second embodiment of the photo-imaging element of the compact and miniature optical navigation device of the present invention; and

FIG. 5 is a schematic diagram of the second embodiment of the compact and miniature optical navigation device of the present invention

### DETAILED DESCRIPTION OF THE PREFERRED EMBODIMENTS

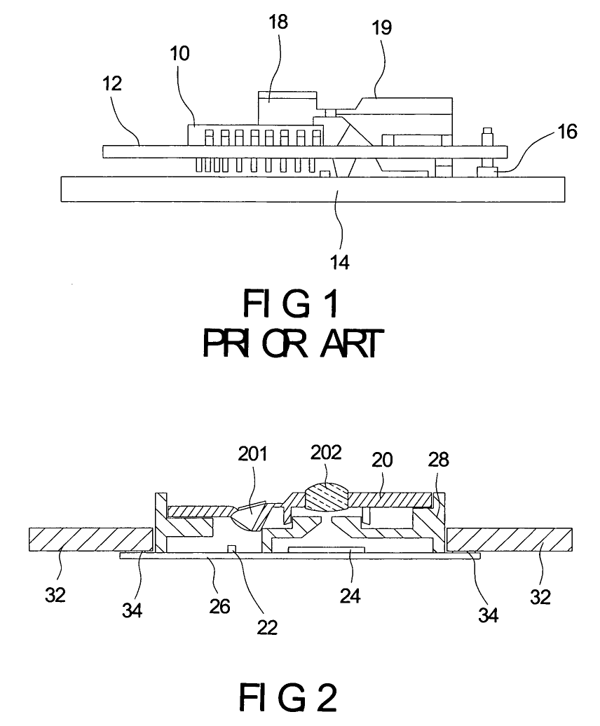

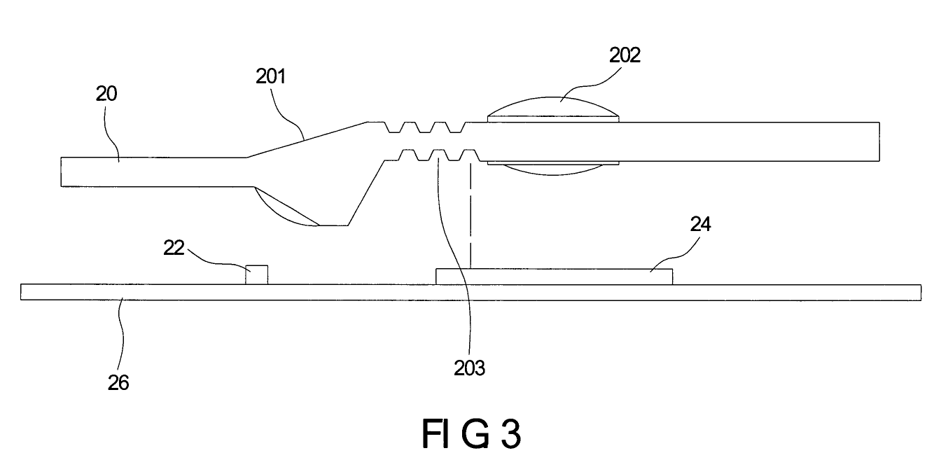

Please refer to FIG. 1, which shows a schematic diagram of the compact and miniature optical navigation device of the present invention. The present invention is an overall compact solution of all optical, mechanical and electrical systems integrated into a small size. Its size is greatly reduced compared to the prior art. In the present invention, the illumination channel 201 and the imaging channel 202 are integrated into one piece. This is achieved by various known molding technologies, such as the photo-imaging element shown in the FIG. 2 to achieve the effect of simplifying the manufacturing process. When the light is emitted from the light source 22, the light passes through the illumination channel 201 and arrives at the surface that the compact and miniature optical navigation device is navigating. Then, the light is reflected from the surface, passes through the imaging channel 202, and is received by a sensor 24. Thereby, the location that the compact and miniature optical navigation device is navigating is known.

The light source 22 can be an LED, a laser diode, or a VCSEL, etc. In a preferred embodiment, the light source 22 and the sensor 24 are mounted at the same plane of a first substrate 26. The first substrate 26 can be a printed circuit board. The first substrate 26 can either be an organic, a non-organic, or a lead frame substrate.

The illumination channel 201 includes a collimating surface, a total internal reflection surface, and a photo wedge where all three elements are molded as one piece. The function of the collimation surface is to collect and collimate the light from the light source 22. The light source can be any wavelength from a visible region to an IR range that depends on the sensor 24. The light emitted from the light source 22 first reaches the collimating surface and is collimated. The collimated light beam is then reflected by the total internal reflection surface. The total internal reflection surface is a flat smooth surface where the angle of the total internal reflection surface is larger than the critical angle of the incident light beam. The reflected light then goes through a photo wedge where the light is bent to a certain angle. The function of the photo wedge is to bend the light beam so that the incident angle of the light beam arriving at the target surface is within an acceptable range that will create good contrast upon the surface where the compact and miniature optical navigation device is navigating on.

The light reflected from the target surface of the compact and miniature optical navigation device is then collected by the imaging channel 202. The imaging channel 202 is composed of an imaging lens. In a preferred embodiment, the imaging lens 202 includes two aspheric surfaces. This is to improve the resolving power of the imaging lens 202 in order to generate a good resolution image formed on the sensor 24. Alternatively, the imaging lens 202 is composed of spherical surfaces or both the aspheric surface and the spherical surface. Moreover, there is an aperture stop which is a molded part integrated in the housing 28. The aperture stop has the function of blocking the stray light from interfering the image formed on the sensor 24.

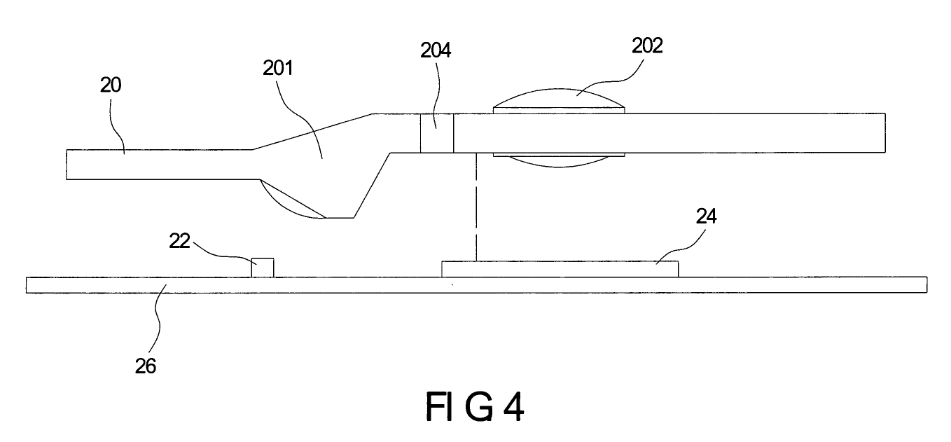

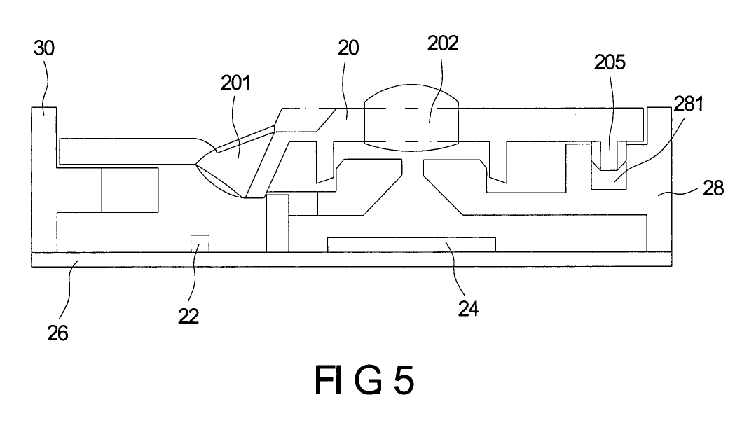

Since the illumination channel 201 is integrated with the imaging channel 202, there will be light traveling along between the illumination channel 201 and the imaging channel 202 due to TIR. This problem is overcome by adding a groove part 203 between the illumination channel 201 and the imaging channel 202, as shown in FIG. 3. In another embodiment, there is a hole 204 between the illumination channel 201 and the imaging channel 202, as shown in FIG. 4, so as to prevent the light from traveling from the illumination channel 201 of the photo-imaging element 20 to the imaging channel 202.

In another embodiment, the collimating element is not required if the light source 22 is a laser diode or a VCSEL. In this embodiment, the light is collimated naturally. Therefore the collimating element is eliminated while the TIR surface and the photo wedge still exist and has the same function as described in earlier embodiments.

In terms of alignment of the optical system to the mechanical system, meaning the alignment of the photo-imaging element 20 to the housing 28, there is a male and a female fitting formed on the photo-imaging element 20 and the volcano feature of the housing 28. The fitting has a snug fit with minimal to no play between two surfaces. Please refer to FIG. 5, for example, there is a post 205 on the photo-imaging element 20 and there is a hole 281 on the volcano feature of the housing 28. The post 205 is installed in the hole 281 of the housing 28. Therefore, the rotation between the photo-imaging element 20 and the housing 28 is controlled. An alternative to prevent rotation is by having a dam wall 30 built around the photo-imaging element 20 to prevent movement between the photo-imaging element 20 and the housing 28.

Refer to FIG. 2. Once the assembly of the photo-imaging element 20, the housing 28, and the first substrate 26 have been completed the assembled module will be surface mounted on a second substrate 32 which consists of other circuitry for different applications or functions of the photo navigation device via the plurality of welding pads 34 located on the first substrate 26. In order to reduce the total height of the compact and miniature optical navigation device, a hole located on the second substrate 32 that fits the outline of the package is drilled or punched to form a through hole. Thereby, the assembled module of the photo-imaging element 20 and the housing 28 can pass through the hole of the second substrate 32. The second substrate 32 is a customer's printed circuit board that matches the application of the compact and miniature optical navigation device.

In order to apply the compact and miniature optical navigation device in high temperature conditions, the photo-imaging element 20 is made of high temp thermo materials.

The compact and miniature optical navigation device of the present invention has the following characteristics:

1. The compact and miniature optical navigation device integrates the illumination channel and the imaging channel into one piece to achieve the effects of miniaturizing the device and simplifying the manufacturing process.

2. The compact and miniature optical navigation device of the present invention integrates the photo system, the mechanical system, and the electrical system into a small form factor device.

3. The compact and miniature optical navigation device can be used in various applications ranging from a hand held navigation tool suitable for application in cell phones to that of computer or lap top navigation devices.

4. Because the customer's printed circuit board has a hole, the assembled part of the photo-imaging element 20 and the housing 28 can pass through the hole of the printed circuit board so that the height of the compact and miniature optical navigation device is reduced.

The description above only illustrates specific embodiments and examples of the invention. The invention should therefore cover various modifications and variations made to the herein-described structure and operations of the invention, provided they fall within the scope of the invention as defined in the following appended claims.

What is claimed is:

1. An compact and miniature optical navigation device, comprising:
a photo-imaging element including an imaging channel and an illumination channel;
a housing with a feature that serve the function of an aperture stop and alignment element, wherein the aperture stop and the housing are integrated as one single molded piece part, and the alignment element is part of the housing and is used for holding and positioning the photo-imaging element; and
a first substrate with a light source such as LED or other light emitting device and a sensor, wherein the light source and the sensor are mounted on the same plane of the first substrate, and the light emitted from the light source passes through the illumination channel, reflected from the navigating surface and forms the image on the sensor through the imaging channel.

2. The compact and miniature optical navigation device as claimed in claim 1, wherein the imaging channel and the illumination channel are integrated into one piece.

3. The compact and miniature optical navigation device as claimed in claim 1, wherein the photo-imaging element further comprises a groove part, wherein the groove part is located between the illumination channel and the imaging channel and prevents the light from traveling from the illumination channel of the photo-imaging element to the imaging channel.

4. The compact and miniature optical navigation device as claimed in claim 1, wherein the photo-imaging element further comprises a hole, wherein the hole is located between the illumination channel and the imaging channel and prevents the light from traveling from the illumination channel of the photo-imaging element to the imaging channel.

5. The compact and miniature optical navigation device as claimed in claim 1, wherein the illumination channel comprises a collimating surface, a total internal reflection surface, and a photo wedge.

6. The compact and miniature optical navigation device as claimed in claim 1, wherein the imaging channel comprises an imaging lens and an aperture stop.

7. The compact and miniature optical navigation device as claimed in claim 1, wherein the first substrate is a printed circuit board.

8. The compact and miniature optical navigation device as claimed in claim 1, wherein the first substrate is an organic, a non-organic, or a lead frame substrate.

9. The compact and miniature optical navigation device as claimed in claim 1, wherein the photo-imaging element further comprises a post and the housing comprises a hole, and the post is installed into the hole of the housing so that the rotation between the photo-imaging element and the housing is controlled.

10. The compact and miniature optical navigation device as claimed in claim 1, further comprising a second substrate, wherein the second substrate comprises a hole so that the assembled module of the photo-imaging element and the housing passes through the hole of the second substrate.

11. The compact and miniature optical navigation device as claimed in claim 10, wherein there are a plurality of soldering pads located on one surface of the first substrate so that the first substrate is electrically connected with the second substrate via the surface mounting technology.

12. The compact and miniature optical navigation device as claimed in claim 1, wherein the photo-imaging element is made of high temp thermo materials.

13. The compact and miniature optical navigation device as claimed in claim 1, wherein the light source is an LED, a laser diode, or a VCSEL.

14. An compact and miniature optical navigation device, comprising:
a photo-imaging element including an imaging channel and an illumination channel, wherein the imaging channel and the illumination channel are integrated into one piece;
a housing including an aperture stop and an alignment element, wherein the aperture stop and the housing are integrated into one piece, and the alignment element is part of the housing and is used for holding and positioning the photo-imaging element;
a first substrate including a sensor;
a light source used for generating a light source;
wherein the light emitted from the light source passes through the photo-imaging element and is received by the sensor.

15. The compact and miniature optical navigation device as claimed in claim 14, wherein the light source and the sensor are mounted at the same plane of the first substrate.

16. The compact and miniature optical navigation device as claimed in claim 14, wherein the photo-imaging element further comprises a groove part, wherein the groove part is located between the illumination channel and the imaging channel and prevents the light from traveling from the illumination channel of the photo-imaging element to the imaging channel.

17. The compact and miniature optical navigation device as claimed in claim 14, wherein the photo-imaging element further comprises a hole, wherein the hole is located between the illumination channel and the imaging channel and prevents the light from traveling from the illumination channel of the photo-imaging element to the imaging channel.

18. The compact and miniature optical navigation device as claimed in claim 14, wherein the illumination channel comprises a collimating surface, a total internal reflection surface, and a photo wedge.

19. The compact and miniature optical navigation device as claimed in claim 14, wherein the imaging channel comprises an imaging lens and an aperture stop.

20. The compact and miniature optical navigation device as claimed in claim 14, wherein the first substrate is a printed circuit board.

21. The compact and miniature optical navigation device as claimed in claim 14, wherein the first substrate is an organic, a non-organic, or a lead frame substrate.

22. The compact and miniature optical navigation device as claimed in claim 14, wherein the photo-imaging element further comprises a post and the housing comprises a hole, where the post is installed into the hole of the housing so that the rotation between the photo-imaging element and the housing is controlled.

23. The compact and miniature optical navigation device as claimed in claim 14, further comprising a second substrate, wherein the second substrate comprises a hole so that the assembled module of the photo-imaging element and the housing passes through the hole of the second substrate.

24. The compact and miniature optical navigation device as claimed in claim 23, wherein there are a plurality of soldering pads located on one surface of the first substrate so that the first substrate is electrically connected with the second substrate via the surface mounting technology.

25. The compact and miniature optical navigation device as claimed in claim 14, wherein the photo-imaging element is made of high temp thermo materials

26. The compact and miniature optical navigation device as claimed in claim 14, wherein the light source is an LED, a laser diode, or a VCSEL.

27. An compact and miniature optical navigation device, comprising:
a photo-imaging element including an imaging channel and an illumination channel that are integrated into one piece, wherein the illumination channel comprises a collimating surface, a total internal reflection surface, and a photo wedge and the imaging channel comprises an imaging lens and an aperture stop;
a housing used for holding and positioning the photo-imaging element; and
a first substrate including a light source and a sensor, wherein the light source and the sensor are mounted on the same plane of the first substrate, and the light emitted from the light source passes through the photo-imaging element and is received by the sensor.

28. The compact and miniature optical navigation device as claimed in claim 27, wherein the photo-imaging element further comprises a groove part, wherein the groove part is located between the illumination channel and the imaging channel and prevents the light from traveling from the illumination channel of the photo-imaging element to the imaging channel.

29. The compact and miniature optical navigation device as claimed in claim 27, wherein the photo-imaging element further comprises a hole, wherein the hole is located between the illumination channel and the imaging channel and prevents the light from traveling from the illumination channel of the photo-imaging element to the imaging channel.

30. The compact and miniature optical navigation device as claimed in claim 27, wherein the first substrate is a printed circuit board.

31. The compact and miniature optical navigation device as claimed in claim 27, wherein the first substrate is an organic, a non-organic, or a lead frame substrate.

32. The compact and miniature optical navigation device as claimed in claim 27, wherein the photo-imaging element further comprises a post and the housing comprises a hole, where the post is installed into the hole of the housing so that the rotation between the photo-imaging element and the housing is controlled.

33. The compact and miniature optical navigation device as claimed in claim 27, further comprising a second substrate, wherein the second substrate comprises a hole so that the assembled module of the photo-imaging element and the housing passes through the hole of the second substrate.

34. The compact and miniature optical navigation device as claimed in claim 33, wherein there are a plurality of soldering pads located on one surface of the first substrate so that the first substrate is electrically connected with the second substrate via the surface mounting technology.

35. The compact and miniature optical navigation device as claimed in claim 27, wherein the photo-imaging element is made of high temp thermo materials

36. The compact and miniature optical navigation device as claimed in claim 27, wherein the light source is an LED, a laser diode, or a VCSEL.
